(19) United States
(12) Patent Application Publication
(10) Pub. No.: US 2006/0116488 A1
(43) Pub. Date: Jun. 1, 2006

(54) Multi-component system and the use thereof for producing a triple cure mixture which can be hardened thermally and by means of actinic radiation

(76) Inventors: Hubert Baumgart, Munster (DE); Vincent Cook, Munster (DE); Thomas Farwick, Billerbeck (DE); Sandra Hasse, Drensteinfurt (DE); Peter Mayenfels, Munster (DE); Guido Schulze-Finkenbrink, Munster (DE)

Correspondence Address: BASF CORPORATION;ANNE GERRY SABOURIN, 26701 TELEGRAPH ROAD, SOUTHFIELD, MI, 48034-2442, US

(21) Appl. No.: 10/541,530

(22) PCT Filed: Nov. 19, 2003
(86) PCT No.: PCT/EP03/12917

§ 371 Date: Jul. 11, 2005

(30) Foreign Application Priority Data
Jan. 13, 2003 (DE) 10300798.9

(51) Int. Cl. C08G 18/06; C08G 18/00

(52) U.S. Cl. 525/452

(57) ABSTRACT

A multicomponent system comprising (I) a component comprising (A) an oligomer and/or polymer containing allophanate groups and/or carbamate groups, (B) an oligomer and/or polymer containing isocyanate-reactive functional groups, (C) a partly or fully alkylated amino resin, and (D) a compound containing groups which can be activated with actinic radiation; and (II) a component comprising (E) a polyisocyanate, with the proviso that the equivalents ratio of isocyanate groups in component (II) to isocyanate-reactive functional groups in component (I) is from 0.2:1 to 1:0.2 and the equivalents ratio of allophanate groups and/or carbamate groups in the oligomer and/or polymer (A) to the N-methylol ether groups or the N-methylol and N-methylol ether groups in the amino resin (C) is from 0.2:1 to 1:0.2; and its use to produce mixtures curable thermally and with actinic radiation.

The invention relates to a novel multicomponent system at least comprising at least one component (I) and at least one component (II). The present invention further relates to the use of the novel multicomponent system to prepare a novel triple-cure mixture curable thermally and with actinic radiation. The present invention additionally relates to the use of the novel triple-cure mixture to produce moldings and films and also as a coating material, adhesive, and sealant to produce coatings, adhesive films, and seals.

European patent application EP 0 915 113 A1 discloses thermally curable mixtures comprising as binders at least one hydroxyl-containing resin and at least one carbamate-functional resin and as crosslinking agents at least one amino resin and at least one polyisocyanate. The examples, however, reveal only mixtures which comprise blocked polyisocyanates and which therefore have not been prepared from multicomponent systems. The proportion of the amino resin is limited so that it reacts only with the carbamate groups and not with the hydroxyl groups. As a result, the hydroxyl groups remain free for the reaction with the polyisocyanates. In this way, two crosslinking mechanisms are realized which can proceed in succession to and/or alongside one another. As a result, the problem of the applied mixture running away during the commencement of thermal crosslinking can be solved. The known thermally curable mixture, however, cannot be cured with actinic radiation.

European patent EP 0 675 141 B1 discloses mixtures curable thermally and with actinic radiation which as binders likewise comprise at least one hydroxyl-containing resin and at least one carbamate-functional resin. As crosslinking agents, it is possible to use amino resins, polyisocyanates, including blocked polyisocyanates, phenolic resins, cycloaliphatic epoxides, glycidyl epoxides, carbodiimides, poly-carbodiimides, and mixtures of these crosslinking agents. The examples reveal only the use of amino resin. The mixtures comprising cycloaliphatic epoxides can be crosslinked by UV radiation in the presence of photoinitiators based on onium salts. The radiation cure proceeds in accordance with a cationic mechanism. Furthermore, the mixtures may additionally comprise N-carbamate (meth)acrylates of the general formula
CH₂═C(R)—C(O)—O—X—O—C(O)—NR′R″
in which R is a hydrogen atom or a methyl group, R′ is a hydrogen atom, R″ is a hydrogen atom or an alkyl group having 1 to 8 carbon atoms, and X is a linear, branched, cyclic, substituted or unsubstituted hydrocarbon radical having from 1 to 20 carbon atoms. These compounds, which contain only one group which can be activated with actinic radiation, may also be used in mixtures which can be crosslinked by electron beams or by UV radiation in accordance with a free-radical mechanism. Further details of this, however, are not given, and the examples reveal only thermally curable mixtures.

The known mixtures curable thermally and also both thermally and with actinic radiation can be used as coating materials to produce comparatively chemically resistant, weathering-stable, and etch-resistant coatings. The heightened requirements on the part of the market, however, call for a further improvement in this profile of properties. Furthermore, it is necessary further to improve the leveling, scratch resistance, wetting and adhesion, condensation resistance, and hardness of the coatings.

It is an object of the present invention to provide a novel multicomponent system which is outstandingly suitable for preparing a novel mixture curable thermally and with actinic radiation. The novel mixture curable thermally and with actinic radiation is to be suitable in particular for producing novel moldings and films and also as a novel coating material, adhesive, and sealant for producing coatings, adhesive films, and seals. In particular, the novel coatings ought to be further improved in terms of their chemical resistance, weathering stability, etch resistance, scratch resistance, hardness, wetting, adhesion, and condensation resistance, and also in their leveling.

The invention accordingly provides the novel multicomponent system at least comprising

(I) at least one component comprising

(A) at least one oligomer and/or polymer containing on average at least two allophanate groups, carbamate groups or at least one carbamate group and at least one allophanate group,
(B) at least one oligomer and/or polymer containing on average at least two isocyanate-reactive functional groups,
(C) at least one partly or fully alkylated amino resin, and
(D) at least one compound containing on average at least two groups which can be activated with actinic radiation;
   and
   (II) one component comprising
(E) at least one polyisocyanate,
   with the proviso that
the equivalents ratio of isocyanate groups in component (II) to isocyanate-reactive functional groups in component (I) is from 0.2:1 to 1:0.2 and
the equivalents ratio of allophanate groups and/or carbamate groups in the oligomer and/or polymer (A) to the N-methylol ether groups or the N-methylol and N-methylol ether groups in the amino resin (C) is from 0.2:1 to 1:0.2.

The novel multicomponent system is referred to below as “multicomponent system of the invention”.

The invention further provides for the use of the multicomponent system of the invention to prepare the novel mixture curable thermally and with actinic radiation, which is referred to below as “triple-cure mixture”.

Further subject matter of the invention will emerge from the description.

In the light of the prior art it was surprising and unforeseeable for the skilled worker that the object on which the present invention was based could be achieved by means of the multicomponent system of the invention and by means of the triple-cure mixture.

In particular it was surprising that the multicomponent system of the invention was extremely widely variable in its physical composition and so resulted in triple-cure mixtures which could be tailored to the particular end use and therefore had particularly advantageous performance properties.

Surprisingly, the triple-cure mixtures had an advantageously long processing time or pot life, but could be cured very rapidly following application.

It was also surprising that the triple-cure mixtures were outstandingly suitable for producing novel moldings and films and also, as coating materials, adhesives and sealants, were outstandingly suitable for producing coatings, adhesive films, and seals.

In particular, the triple-cure mixtures gave coatings which in terms of their chemical resistance, weathering stability, condensation resistance, etch resistance, scratch resistance, hardness, wetting, and adhesion and also in their leveling were superior to the coatings of the prior art.

In the context of the present invention actinic radiation means electromagnetic radiation, such as near infrared (NIR), visible light, UV radiation, X-rays or gamma radiation, especially UV radiation, and corpuscular radiation, such as electron beams, alpha radiation, beta radiation or neutron beams, especially electron beams.

Additionally, in the context of the present invention, oligomers are resins containing at least 2 to 15 repeating monomer units in their molecule. Polymers in the context of the present invention are resins containing at least 10 repeating monomer units in their molecule. For further details of these terms refer to Römpp Lexikon Lacke und Druckfarben, Georg Thieme Verlag, Stuttgart, New York, 1998, “Oligomers”, page 425.

The multicomponent system of the invention at least comprises at least one, especially one, component (I) and at least one, especially one, component (II). In the preferred embodiment of the multicomponent system of the invention it is therefore a two-component system. Components (I) and (II) are stored separately from one another until the multicomponent system of the invention is used, in particular to prepare the triple-cure mixtures, in order to prevent premature crosslinking.

Component (I) comprises at least one, especially one, oligomer and/or polymer (A) containing on average at least two, preferably at least three, and in particular at least four allophanate groups or carbamate groups or at least one carbamate group and at least one allophanate group, preferably at least two carbamate groups and at least two allophanate groups.

Additionally, the oligomer and the polymer (A) may also contain isocyanate-reactive functional groups. Examples of suitable isocyanate-reactive functional groups are hydroxyl groups, thiol groups, and primary and secondary amino groups, especially hydroxyl groups. The amount of these groups is preferably up to 30 equivalent %, in particular up to 10 equivalent %, based on the allophanate groups and/or carbamate groups and isocyanate-reactive functional groups present in the oligomer and/or polymer (A).

The oligomer and the polymer (A) may originate from any of a very wide variety of oligomer and polymer classes. Examples of suitable oligomer and polymer classes are random, alternating and/or block, linear and/or branched and/or comb polyaddition resins, polycondensation resins, and addition (co)polymers of ethylenically unsaturated monomers. For further details of these terms refer to Römpp Lexikon Lacke und Druckfarben, Georg Thieme Verlag, Stuttgart, New York, 1998, page 457, “Polyaddition” and “Polyaddition resins (polyadducts)”, and also pages 463 and 464, “Polycondensates”, “Polycondensation”, and “Polycondensation resins”.

Examples of highly suitable polyaddition resins and/or polycondensation resins (A) are polyesters, alkyds, polyurethanes, polylactones, polycarbonates, polyethers, epoxy resin-amine adducts, polyureas, polyamides, and polyimides.

Examples of highly suitable addition (co)polymers (A) are (meth)acrylate (co)polymers and polyvinyl esters, especially (meth)acrylate (co)polymers.

Oligomers and polymers (A) which contain allophanate groups and come from the abovementioned polymer classes are known from German patent application DE 198 39 453 A1, page 2 line 65 to page 6 line 34 and page 7 lines 25 to 53.

Oligomers and polymers (A) which contain carbamate groups and come from the abovementioned polymer classes, and processes for preparing them, are known from patent applications
EP 0 594 068 A1, page 2 line 45 to page 4 line 27, page 5 lines 36 to 57, and page 7 lines 1 to 22,
EP 0 594 142 A1, page 3 line 1 to page 4 line 37, page 5 line 49 to page 6 line 12, and page 7 lines 5 to 26,
EP 0 675 141 B1, page 2 line 44 to page 5 line 15 and page 8 line 5 to page 10 line 41, and
WO 94/10211, page 4 line 18 to page 8 line 8, page 12 line 30 to page 14 line 36, page 15 line 35 to page 17 line 32, and page 18 line 16 to page 19 line 30,
   or are described in German patent application
DE 199 46 048 A1.

Component (I) further comprises at least one, especially one, oligomer and/or polymer (B) containing on average at least two, preferably at least three, and in particular at least four of the above-described isocyanate-reactive functional groups, especially hydroxyl groups.

The oligomer and the polymer (B) may originate from the polymer classes described above. The oligomer and the polymer (B) are preferably (meth)acrylate (co)polymers, especially (meth)acrylate copolymers.

Examples of suitable olefinically unsaturated monomers
(b) for preparing the (meth)acrylate copolymers (B) are
(b1) monomers which carry at least one hydroxyl or amino group per molecule, such as
   hydroxyalkyl esters of acrylic acid, methacrylic acid or another alpha,beta-olefinically unsaturated carboxylic acid, which are derived from an alkylene glycol which is esterified with the acid, or which are obtainable by reacting the alpha,beta-olefinically unsaturated carboxylic acid with an alkylene oxide such as ethylene oxide or propylene oxide, especially hydroxyalkyl esters of acrylic acid, methacrylic acid, ethacrylic acid, crotonic acid, maleic acid, fumaric acid or itaconic acid, in which the hydroxyalkyl group contains up to 20 carbon atoms, such as 2-hydroxyethyl, 2-hydroxypropyl, 3-hydroxy-propyl, 3-hydroxybutyl, 4-hydroxybutyl acrylate, methacrylate, ethacrylate, crotonate, maleate, fumarate or itaconate; or hydroxy-cycloalkyl esters such as 1,4-bis(hydroxy-methyl)cyclohexane, octahydro-4,7-methano-1H-indenedimethanol or methylpropanediol mono-acrylate, monomethacrylate, monoethacrylate, monocrotonate, monomaleate, monofumarate or monoitaconate; reaction products of cyclic esters, such as epsilon-caprolactone and these hydroxyalkyl or hydroxycycloalkyl esters;
   olefinically unsaturated alcohols such as allyl alcohol;
   polyols such as trimethylolpropane monoallyl or diallyl ether or pentaerythritol monoallyl, diallyl or triallyl ether;
   reaction products of acrylic acid and/or methacrylic acid with the glycidyl ester of an alpha-branched monocarboxylic acid having 5 to 18 carbon atoms per molecule, especially a Versatic® acid, or instead of the reaction product an equivalent amount of acrylic and/or methacrylic acid, which is then reacted during or after the polymerization reaction with the glycidyl ester of an alpha-branched mono-carboxylic acid having 5 to 18 carbon atoms per molecule, especially a Versatic® acid;
   aminoethyl acrylate, aminoethyl methacrylate, allylamine or N-methyliminoethyl acrylate; and/or
   acryloyloxysilane-containing vinyl monomers, preparable by reacting hydroxy-functional silanes with epichlorohydrin and then reacting that reaction product with (meth)acrylic acid and/or hydroxyalkyl esters and/or hydroxy-cycloalkyl esters of (meth)acrylic acid and/or other hydroxyl-containing monomers (b1).
(b2) Monomers which carry at least one acid group per molecule, such as
   acrylic acid, beta-carboxyethyl acrylate, methacrylic acid, ethacrylic acid, crotonic acid, maleic acid, fumaric acid or itaconic acid;
   olefinically unsaturated sulfonic or phosphonic acids or their partial esters;
   mono(meth)acryloyloxyethyl maleate, succinate or phthalate; or
   vinylbenzoic acid (all isomers), alpha-methylvinylbenzoic acid (all isomers) or vinylbenzenesulfonic acid (all isomers).
(b3) Monomers which are substantially or entirely free from reactive functional groups, such as:

Monomers (b31):
(Meth)acrylic esters which are substantially free from acid groups, such as (meth)acrylic alkyl or cycloalkyl esters having up to 20 carbon atoms in the alkyl radical, especially methyl, ethyl, n-propyl, n-butyl, sec-butyl, tert-butyl, hexyl, ethylhexyl, stearyl and lauryl acrylate or methacrylate; cycloaliphatic (meth)acrylic esters, especially cyclohexyl, isobornyl, dicyclopentadienyl, octahydro-4,7-methano-1H-indenemethanol or tert-butylcyclohexyl (meth)acrylate; (meth)acrylic oxaalkyl or oxacycloalkyl esters such as ethoxytriglycol (meth)acrylate and methoxy-oligoglycol (meth)acrylate having a molecular weight Mn of preferably 550 or other ethoxylated and/or propoxylated, hydroxyl-free (meth)acrylic acid derivatives (further examples of suitable monomers (31) of this kind are known from the laid-open specification DE 196 25 773 A1, column 3 line 65 to column 4 line 20). In minor amounts they may contain higher-functional (meth)acrylic alkyl or cycloalkyl esters such as ethylene glycol, propylene glycol, diethylene glycol, dipropylene glycol, butylene glycol, 1,5-pentanediol, 1,6-hexanediol, octahydro-4,7-methano-1H-indenedimethanol or cyclohexane-1,2-, -1,3- or -1,4-diol di(meth)acrylate; trimethylolpropane di- or tri(meth)acrylate; or pentaerythritol di-, tri- or tetra(meth)acrylate. In the context of the present invention, minor amounts of higher-functional monomers (b31) are amounts which do not lead to crosslinking or gelling of the copolymers, unless the intention is that they should be in the form of crosslinked microgel particles.

Monomers (b32):
Vinyl esters of alpha-branched monocarboxylic acids having 5 to 18 carbon atoms in the molecule. The branched monocarboxylic acids may be obtained by reacting formic acid or carbon monoxide and water with olefins in the presence of a liquid, strongly acidic catalyst; the olefins may be cracking products of paraffinic hydrocarbons, such as mineral oil fractions, and may comprise branched and straight-chain acyclic and/or cycloaliphatic olefins. The reaction of such olefins with formic acid or with carbon monoxide and water produces a mixture of carboxylic acids in which the carboxyl groups are located predominantly on a quaternary carbon atom. Other olefinic starting materials are, for example, propylene trimer, propylene tetramer and diisobutylene. Alternatively, the vinyl esters may be prepared in a conventional manner from the acids; for example, by reacting the acid with acetylene. Particular preference, owing to their ready availability, is given to the use of vinyl esters of saturated aliphatic monocarboxylic acids having 9 to 11 carbon atoms which are branched on the alpha carbon atom. Vinyl esters of this kind are sold under the brand name VeoVa® (cf. also Römpp, op. cit., page 598).

Monomers (b33):
Diarylethylenes, especially those of the general formula I:
   R¹R²C═CR³R⁴ (I),
   in which the radicals R¹, R², R³ and R⁴ in each case independently of one another are hydrogen atoms or substituted or unsubstituted alkyl, cycloalkyl, alkylcycloalkyl, cycloalkylalkyl, aryl, alkylaryl, cycloalkylaryl, arylalkyl or arylcycloalkyl radicals, with the proviso that at least two of the variables R¹, R², R³ and R⁴ are substituted or unsubstituted aryl, arylalkyl or arylcycloalkyl radicals, especially substituted or unsubstituted aryl radicals. Examples of suitable alkyl radicals are methyl, ethyl, propyl, isopropyl, n-butyl, isobutyl, tert-butyl, amyl, hexyl or 2-ethylhexyl. Examples of suitable cycloalkyl radicals are cyclobutyl, cyclopentyl or cyclohexyl. Examples of suitable alkylcycloalkyl radicals are methylenecyclohexane, ethylene-cyclohexane or propane-1,3-diylcyclohexane. Examples of suitable cycloalkylalkyl radicals are 2-, 3- or 4-methyl-, -ethyl-, -propyl- or -butylcyclohex-1-yl. Examples of suitable aryl radicals are phenyl, naphthyl or biphenylyl, preferably phenyl and naphthyl and especially phenyl. Examples of suitable alkylaryl radicals are benzyl or ethylene- or propane-1,3-diylbenzene. Examples of suitable cycloalkylaryl radicals are 2-, 3- or 4-phenylcyclohex-1-yl. Examples of suitable arylalkyl radicals are 2-, 3- or 4-methyl-, -ethyl-, -propyl- or -butylphen-1-yl. Examples of suitable arylcycloalkyl radicals are 2-, 3- or 4-cyclohexylphen-1-yl. The aryl radicals R¹, R², R³ and/or R⁴ are preferably phenyl or naphthyl radicals, especially phenyl radicals. The substituents that may be present in the radicals R¹, R², R³ and/or R⁴ are electron-withdrawing or electron-donating atoms or organic radicals, especially halogen atoms, nitrile, nitro, partially or fully halogenated alkyl, cycloalkyl, alkylcycloalkyl, cycloalkylalkyl, aryl, alkylaryl, cycloalkylaryl, arylalkyl and arylcycloalkyl radicals; aryloxy, alkyloxy and cycloalkyloxy radicals; and/or arylthio, alkylthio and cycloalkylthio radicals. Diphenylethylene, dinaphthaleneethylene, cis- or trans-stilbene or vinylidenebis(4-nitrobenzene), especially diphenylethylene (DPE), are particularly advantageous and so are used with preference. In the context of the present invention, the monomers (b33) are used in order to regulate the copolymerization advantageously such that batchwise free-radical copolymerization is also possible.

Monomers (b34):
Vinylaromatic hydrocarbons such as styrene, vinyl-toluene, diphenylethylene or alpha-alkylstyrenes, especially alpha-methylstyrene.

Monomers (b35):
Nitriles such as acrylonitrile and/or methacrylonitrile;

Monomers (b36):
Vinyl compounds, especially vinyl halides and/or vinylidene dihalides, such as vinyl chloride, vinyl fluoride, vinylidene dichloride or vinylidene difluoride; N-vinyl amides such as vinyl-N-methylformamide, N-vinylcaprolactam or N-vinylpyrrolidone; 1-vinylimidazole; vinyl ethers such as ethyl vinyl ether, n-propyl vinyl ether, isopropyl vinyl ether, n-butyl vinyl ether, isobutyl vinyl ether and/or vinyl cyclohexyl ether; and/or vinyl esters such as vinyl acetate, vinyl propionate, vinyl butyrate, vinyl pivalate and/or the vinyl ester of 2-methyl-2-ethylheptanoic acid.

Monomers (b37):
Allyl compounds, especially allyl ethers and allyl esters such as allyl methyl, ethyl, propyl or butyl ether or allyl acetate, propionate or butyrate.

Monomers (b38):
Polysiloxane macromonomers having a number-average molecular weight Mn of from 1 000 to 40 000 and having on average from 0.5 to 2.5 ethylenically unsaturated double bonds per molecule; especially polysiloxane macromonomers having a number-average molecular weight Mn of from 2 000 to 20 000, with particular preference from 2 500 to 10 000, and in particular from 3 000 to 7 000 and having on average from 0.5 to 2.5, preferably from 0.5 to 1.5, ethylenically unsaturated double bonds per molecule, as are described in DE 38 07 571 A1 on pages 5 to 7, in DE 37 06 095 A1 in columns 3 to 7, in EP 0 358 153 B1 on pages 3 to 6, in U.S. Pat. No. 4,754,014 A1 in columns 5 to 9, in DE 44 21 823 A1 or in the international patent application WO 92/22615 on page 12 line 18 to page 18 line 10.

Monomers (b39):
Olefins such as ethylene, propylene, but-1-ene, pent-1-ene, hex-1-ene, cyclohexene, cyclopentene, norbornene, butadiene, isoprene, cyclopentadiene and/or dicyclopentadiene.
(b4) Monomers containing epoxide groups, such as the glycidyl ester of acrylic acid, methacrylic acid, ethacrylic acid, crotonic acid, maleic acid, fumaric acid or itaconic acid or allyl glycidyl ether.

Higher-functional monomers (b) of the type described above are generally used in minor amounts. In the context of the present invention, minor amounts of higher-functional monomers are amounts which do not lead to crosslinking or gelling of the (meth)acrylate copolymers (B), unless the specific intention is to produce crosslinked polymeric microparticles.

Depending on the intended use of the coating material of the invention, the (meth)acrylate copolymers (B) have a glass transition temperature of from −50° C. to +110, preferably from −30 to +80, more preferably from −15 to +70, with particular preference from −15 to +50, with very particular preference from −15 to +40, and in particular from −15 to +30° C. Their acid number is guided in particular by whether they are to be used in aqueous coating materials of the invention; preferably, the acid number is from 5 to 100 mg KOH/g. Similarly, the amount of isocyanate-reactive groups they contain, especially hydroxyl groups, may vary widely; preferably, their hydroxyl number is from 20 to 300, more preferably from 30 to 250, with particular preference from 40 to 200, with very particular preference from 60 to 190, and in particular from 80 to 180 mg KOH/g. Particular advantages result from the use of the (b2) monomers 2-hydroxypropyl, 3-hydroxypropyl, 3-hydroxybutyl and 4-hydroxybutyl acrylate and methacrylate.

Examples of suitable preparation processes for (meth)acrylate copolymers (B) are described in European patent application EP 0 767 185 A1, in German patents DE 22 14 650 B1 and DE 27 49 576 B1 and in American patents U.S. Pat. No. 4,091,048 A1, U.S. Pat. No. 3,781,379 A1, U.S. Pat. No. 5,480,493 A1, U.S. Pat. No. 5,475,073 A1 and U.S. Pat. No. 5,534,598 A1, or in the standard work Houben-Weyl, Methoden der organischen Chemie, 4th edition, volume 14/1, pages 24 to 255, 1961. Suitable reactors for the copolymerization include the customary and known stirred tanks, stirred tank cascades, tube reactors, loop reactors or Taylor reactors, such as are described, for example, in the patents and patent applications DE 1 071 241 B1, EP 0 498 583 A1, and DE 198 28 742 A1, or in the article by K. Kataoka in Chemical Engineering Science, volume 50, number 9, 1995, pages 1409 to 1416.

The above-described (meth)acrylate copolymers (B) may serve, as is known, to prepare the oligomers and polymers (A).

Besides the obligatory isocyanate-reactive functional groups, the oligomer and the polymer (B) may contain allophanate groups and/or carbamate groups in minor amounts. These groups are present in a minor amount when the crosslinking properties of the oligomer and of the polymer (B) are determined primarily by the isocyanate-reactive functional groups. The minor amount is preferably up to 30 equivalent %, in particular up to 10 equivalent %, based on the allophanate groups and/or carbamate groups and isocyanate-reactive functional groups present in the oligomer and/or polymer (B).

The oligomers and polymers (A) and/or (B) may further comprise small amounts of the groups described below which can be activated with actinic radiation and also of customary and known, thermally activable, reactive functional groups which are not isocyanate-reactive functional groups, carbamate groups or allophanate groups. It is essential that these groups do not inhibit or prematurely initiate the crosslinking reactions in the triple-cure mixtures. The small amounts are preferably up to 10 equivalent %, based on the reactive functional groups present in the oligomers and polymers (A) and/or (B).

Furthermore, the oligomers and polymers (A) and/or (B) may contain customary and known, (potentially) cationic or anionic, dispersing functional groups if the triple-cure mixtures in question are to be dispersible in water or aqueous media (cf. Römpp, op. cit., “Water-dispersible binders”, page 619, and “Water-soluble binders”, pages 625 and 626).

The oligomers and polymers (A) preferably contain only carbamate groups or carbamate groups and hydroxyl groups.

The oligomers and polymers (B) preferably contain only hydroxyl groups and also, if desired, small amounts of carboxyl groups.

Component (I) further comprises at least one, especially one, partly or fully, especially fully, alkylated amino resin (C). The amino resin (C) is preferably alkylated with methyl groups and/or n-butyl groups.

Examples of highly suitable amino resins (C) include melamine resins, guanamine resins, and urea resins. In this context it is possible to use any amino resin suitable for transparent topcoat or clearcoat materials, or a mixture of such amino resins. For further details refer to Römpp, op. cit., page 29, “Amino resins”, and to the text book “Lackadditive” [Additives for coatings] by Johan Bieleman, Wiley-VCH, Weinheim, New York, 1998, page 242 ff., or to the book “Paints, Coatings and Solvents”, second, completely revised edition, edited by D. Stoye and W. Freitag, Wiley-VCH, Weinheim, New York, 1998, page 80 ff. Also suitable are the customary and known amino resins some of whose methylol and/or methoxymethyl groups have been defunctionalized by means of carbamate or allophanate groups. Crosslinking agents of this kind are described in patents U.S. Pat. No. 4,710,542 A1 and EP 0 245 700 B1 and also in the article by B. Singh and coworkers, “Carbamylmethylated Melamines, Novel Crosslinkers for the Coatings Industry” in Advanced Organic Coatings Science and Technology Series, 1991, Volume 13, page 193 to 207.

Component (I) comprises not least at least one, especially one, compound (D) containing on average at least two, preferably at least three, more preferably at least four, and in particular at least five groups which can be activated with actinic radiation.

The groups which can be activated with actinic radiation contain at least one, especially one, bond which can be activated with actinic radiation.

Examples of suitable bonds which can be activated with actinic radiation are carbon-hydrogen single bonds or carbon-carbon, carbon-oxygen, carbon-nitrogen, carbon-phosphorus or carbon-silicon single bonds or double bonds or carbon-carbon triple bonds. Of these, the carbon-carbon double and triple bonds, especially the carbon-carbon double bonds (“double bonds”), are employed with preference.

Highly suitable double bonds are present, for example, in (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups; ethenylarylene ether, dicyclopentadienyl ether, norbornenyl ether, isoprenyl ether, isopropenyl ether, allyl ether or butenyl ether groups; or ethenylarylene ester, dicyclopentadienyl ester, norbornenyl ester, isoprenyl ester, isopropenyl ester, allyl ester or butenyl ester groups.

Of these, (meth)acrylate groups, especially acrylate groups, are of particular advantage and are therefore used with very particular preference in accordance with the invention.

The compound (D) may be of low molecular mass or oligomeric or polymeric.

Examples of suitable low molecular mass, oligomeric and/or polymeric compounds (D) are described in detail in Römpp, op. cit., “Reactive diluents”, pages 491 and 492, in German patent application DE 199 08 013 A1, column 6 line 63 to column 8 line 65, in German patent application DE 199 08 018 A1, page 11 lines 31 to 33, in German patent application DE 198 18 735 A1, column 7 lines 1 to 35, or in German patent DE 197 09 467 C1, page 4 line 36 to page 5 line 56. It is preferred to use pentaerythritol tetraacrylate, dipentaerythritol pentaacrylate and/or aliphatic urethane acrylates having six acrylate groups in the molecule.

Component (II) of the multicomponent system of the invention comprises or consists of at least one polyisocyanate (E). It preferably comprises at least two, especially two, polyisocyanates (E) or consists thereof.

Suitable polyisocyanates (E) include in principle all of the customary and known aliphatic, cycloaliphatic, aliphatic-cycloaliphatic, aromatic, aliphatic-aromatic and/or cycloaliphatic-aromatic polyisocyanates and polyisocyanate adducts that are used in the paints field, which are also referred to as paint polyisocyanates.

Examples of suitable polyisocyanates (E) are isophorone diisocyanate (i.e., 5-isocyanato-1-isocyanatomethyl-1,3,3-trimethylcyclohexane), 5-isocyanato-1-(2-isocyanatoeth-1-yl)-1,3,3,-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, dicyclohexylmethane 4,4′-diisocyanate, liquid dicyclohexylmethane 4,4′-diisocyanate with a trans/trans content of up to 30% by weight, preferably 25% by weight and in particular 20% by weight, obtainable by phosgenating isomer mixtures of bis(4-aminocyclohexyl)methane or by fractional crystallization of commercial bis(4-isocyanatocyclohexyl)methane in accordance with patents DE 44 14 032 A1, GB 1220717 A, DE 16 18 795 A1 or DE 17 93 785 A1; trimethylene diisocyanate, tetramethylene diisocyanate, pentamethylene diisocyanate, hexamethylene diisocyanate, ethylethylene diisocyanate, trimethylhexane diisocyanate, heptamethylene diisocyanate or diisocyanates derived from dimer fatty acids, as sold by Henkel under the trade name DDI 1410 and described in patents WO 97/49745 A and WO 97/49747 A, especially 2-heptyl-3,4-bis(9-isocyanatononyl)-1-pentylcyclohexane, 1,2-, 1,4- or 1,3-bis(isocyanatomethyl)cyclohexane, 1,2-, 1,4- or 1,3-bis(2-isocyanatoeth-1-yl)cyclohexane, 1,3-bis(3-isocyanatoprop-1-yl)cyclohexane or 1,2-, 1,4- or 1,3-bis(4-isocyanatobut-1-yl)cyclohexane, m-tetramethylxylylene diisocyanate (i.e., 1,3-bis(2-isocyanatoprop-2-yl)benzene) or tolylene diisocyanate.

Examples of suitable polyisocyanates (E) based on the above-described diisocyanates (E) are polyurethane prepolymers containing isocyanate groups, prepared by reacting polyols with an excess of at least one of the above-described diisocyanates, and/or polyisocyanates containing isocyanurate, biuret, allophanate, iminooxadiazinedione, urethane, urea and/or uretdione groups. Preference is given to using isocyanates (E) containing on average from 2 to 5 isocyanate groups per molecule and having viscosities of from 100 to 10 000, preferably from 100 to 5 000, mPas. Furthermore, the polyisocyanates may have been conventionally hydrophilically or hydrophobically modified.

Examples of suitable preparation processes are known, for example, from patents CA 2,163,591 A, U.S. Pat. No. 4,419,513 A, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A1, U.S. Pat. No. 5,290,902 A1, EP 0 649 806 A1, DE 42 29 183 A1 or EP 0 531 820 A1.

Also suitable are the high-viscosity polyisocyanates (E) as described in German patent application DE 198 28 935 A1 or the polyisocyanate particles surface-deactivated by urea formation and/or blocking, in accordance with European patent applications EP 0 922 720 A1, EP 1 013 690 A1, and EP 1 029 879 A1.

The polyisocyanates (E) may be partly blocked with conventional blocking agents. The blocked isocyanate groups, however, should be present only in minor amounts, preferably only up to 50 equivalent %, based on the isocyanate groups present in the polyisocyanate (E). Moreover, the polyisocyanates (E) may contain at least one of the above-described groups which can be activated with actinic radiation (cf. European patent application EP 0 982 800 A1). It is essential that there are still sufficient free isocyanate groups for crosslinking by way of the isocyanate-reactive functional groups in component (I).

For the multicomponent system of the invention it is essential that
the equivalents ratio of isocyanate groups in component (II) to isocyanate-reactive functional groups in component (I) is from 0.2:1 to 1:0.2, preferably from 0.25:1 to 1:0.25, and in particular from 0.3:1 to 1:0.3, and
the equivalents ratio of allophanate groups and/or carbamate groups in the oligomer and/or polymer (A) and also, where appropriate, in the oligomer and/or polymer (B) to the N-methylol ether groups or the N-methylol and N-methylol ether groups in the amino resin (C) is from 0.2:1 to 1:0.2, preferably from 0.25:1 to 1:0.25, and in particular from 0.3:1 to 1:0.3.

For the multicomponent system of the invention it is of advantage if the equivalents ratio of
isocyanate groups+N-methylol ether groups or N-methylol and N-methylol ether groups (crosslinking agent groups) to
isocyanate-reactive functional groups+allophanate groups and/or carbamate groups (binder groups)
   is from 0.2:1 to 1:0.2, preferably from 0.25:1 to 1:0.25.

Accordingly, the composition of component (I) and of component (II) and the proportion of component (I) to component (II) are chosen so as to give the desired equivalents ratios. Quantitatively, therefore, the amount of the constituents in components (I) and (II) and also their proportion may vary widely.

Preferably, component (I) comprises
from 5 to 30%, more preferably from 10 to 28%, and in particular from 15 to 25% by weight of (A),
from 5 to 30%, more preferably from 10 to 28%, and in particular from 15 to 25% by weight of (B),
from 1 to 10%, more preferably from 2 to 8%, and in particular from 3 to 7% by weight of (C), and
from 20 to 70%, more preferably from 25 to 65%, and in particular from 30 to 60% by weight of (D),
   based in each case on the solids of component (I).

Preferably, component (II), based on the solids, contains from 50 to 100%, in particular from 60 to 100% by weight of polyisocyanate (E).

The “solids” of a component (I) or (II) or of a triple-cure mixture is formed by all of the nonvolatile constituents which after curing make up the solids of a molding, film, coating, adhesive film, or seal.

The multicomponent system of the invention may comprise at least one customary and known additive (F) in customary and known, effective amounts.

Examples of suitable additives (F) are organic and inorganic, colored and achromatic, optical effect, electrically conductive, magnetically shielding, and fluorescent pigments, transparent and opaque, organic and inorganic fillers, nanoparticles, oligomeric and polymeric binders other than (A) and (B), crosslinking agents other than (C) and (B), low-boiling and/or high-boiling (“long”) organic solvents, UV absorbers, light stabilizers, free-radical scavengers, photoinitiators, thermolabile free-radical initiators, crosslinking catalysts, devolatilizers, slip additives, polymerization inhibitors, defoamers, emulsifiers, wetting agents, adhesive promoters, leveling agents, film-forming auxiliaries, sag control agents (SCAs), rheology control additives, flame retardants, and flatting agents.

Except for the organic solvents, the additives (F) are preferably present only in component (I).

Components (I) and (II) are preferably prepared by mixing the above-described constituents in suitable mixing equipment such as stirred tanks, stirrer mills, extruders, kneading apparatus, Ultraturrax, in-line dissolvers, static mixers, micromixers, toothed-wheel dispersers, pressure release nozzles and/or microfluidizers. It is preferable here to operate in the absence of light with a wavelength λ<550 nm or in the complete absence of light, in order to prevent premature crosslinking of component (I) and, where appropriate, of a component (II) which can be activated with actinic radiation.

The multicomponent system of the invention serves for the preparation of triple-cure mixtures. In this case, at least one component (I) and at least one component (II) are mixed with one another and the resultant mixture is then homogenized. This can be done using the above-described mixing equipment and methods. Here again it is advisable to operate in the absence of actinic radiation in order to prevent premature crosslinking of the triple-cure mixtures.

The triple-cure mixtures serve for the production of materials cured thermally and with actinic radiation, particularly moldings and films, coatings, adhesive films, and seals.

To produce the moldings and films of the invention the triple-cure mixtures are applied to customary and known, temporary or permanent substrates. For producing the films and moldings of the invention it is preferred to use customary and known temporary substrates, such as metal and polymer belts or hollow bodies made of metal, glass, plastic, wood or ceramic, which can be easily removed without damaging the films and moldings of the invention.

Where the triple-cure mixtures are used as coating materials, adhesives, and sealants to produce coatings, adhesive films, and seals, permanent substrates are used, such as means of transport, including aircraft, boats, rail vehicles, vehicles driven by muscle power and motor vehicles, and parts thereof, the interior and exterior of buildings and parts thereof, doors, windows, and furniture, and also, in the context of industrial coating, substrates such as hollow glassware, coils, freight containers, packaging, small industrial parts, such as nuts, bolts or hubcaps, optical components, electrical components, such as wound articles, including coils and stators and rotors for electric motors, mechanical components, and components for white goods, including household appliances, boilers, and radiators. The films and moldings of the invention may likewise serve as substrates.

In terms of method, the application of the triple-cure mixtures has no special features but may instead take place by any customary and known application method, such as by spraying, squirting, knifecoating, brushing, pouring, dipping, trickling or rolling, for example. During application it is advisable to operate in the absence of actinic radiation in order to prevent premature crosslinking of the triple-cure mixtures.

The applied triple-cure mixtures are preferably cured with UV radiation. For irradiation it is preferred to use a radiation dose of from 100 to 6 000, preferably from 200 to 3 000, more preferably from 300 to 2 000, and with particular preference from 500 to 1 800 mJ cm⁻², with the region <1 700 mJ cm⁻² being especially preferred.

The radiation intensity may be varied widely. It is guided in particular by the radiation dose on the one hand and the irradiation time on the other. The irradiation time is guided, for a given radiation dose, by the belt speed or advance speed of the substrates in the irradiation unit, and vice versa. The radiation dose is preferably measured using a Dosimeter Light Bug® IL 390 C from International Light.

As sources of the UV radiation it is possible to use all customary and known UV lamps. Flash lamps are also suitable. As UV lamps it is preferred to use mercury vapor lamps, preferably low, medium, and high pressure mercury vapor lamps, particularly medium pressure mercury vapor lamps. Particular preference is given to using unmodified mercury vapor lamps plus appropriate filters, or modified, especially doped, mercury vapor lamps.

It is preferred to use gallium-doped and/or iron-doped, especially iron-doped, mercury vapor lamps, as described, for example, in R. Stephen Davidson, “Exploring the Science, Technology and Applications of U.V. and E.B. Curing”, Sita Technology Ltd., London, 1999, Chapter I, “An Overview”, page 16, FIG. 10, or Dipl.-Ing. Peter Klamann, “eltosch System-Kompetenz, UV-Technik, Leitfaden für Anwender” page 2, October 1998.

Examples of suitable flash lamps are flash lamps from the company VISIT.

The distance of the UV lamps from the applied materials of the invention may vary surprisingly widely and can therefore be adapted very effectively to the requirements of the case in hand. The distance is preferably from 2 to 200 cm, more preferably from 5 to 100 cm, with particular preference from 10 to 50 cm, and in particular from 15 to 30 cm. The lamp arrangement may also be adapted to the circumstances of the substrate and the process parameters. In the case of substrates of complex shape, such as are envisaged for automobile bodies, those regions not accessible to direct radiation (shadow regions), such as cavities, folds, and other structural undercuts, may be cured using pointwise, small-area or all-round emitters, in conduction with an automatic movement means for the irradiation of cavities or edges.

Irradiation may be conducted under an oxygen-depleted atmosphere. “Oxygen-depleted” means that the oxygen content of the atmosphere is less than the oxygen content of air (20.95% by volume). The atmosphere may in principle also be oxygen-free, in other words, may be composed of an inert gas. Owing to the lack of the inhibitory effect of oxygen, however, this may result in a sharp acceleration of the radiation cure, which may in turn give rise to inhomogeneities and stresses in the cured materials of the invention. It is therefore of advantage not to reduce the oxygen content of the atmosphere to zero % by volume.

The thermal cure may be effected, for example, with the aid of a gaseous, liquid and/or solid, hot medium, such as hot air, heated oil or heated rollers, or with the aid of microwave radiation, infrared light and/or near infrared (NIR) light. Heating takes place preferably in a forced air oven or by irradiation using IR and/or NIR lamps. As in the case of the actinic radiation cure, the thermal cure may also take place in stages. The thermal cure takes place advantageously at temperatures from room temperature to 200° C.

Both the thermal cure and the actinic radiation cure may be conducted in stages. If so, they may be carried out in succession (sequentially) or simultaneously. In accordance with the invention, sequential curing is of advantage and is therefore used with preference. It is especially advantageous in this case to carry out the thermal cure after the actinic radiation cure.

The resultant films, moldings, coatings, adhesive films, and seals of the invention are outstandingly suitable for the coating, impregnation, adhesive bonding, sealing, wrapping, and packing of means of transport, including aircraft, boats, rail vehicles, vehicles driven by muscle power and motor vehicles, and parts thereof, the interior and exterior of buildings and parts thereof, furniture, doors, windows, and also, in the context of industrial coating, hollow glassware, coils, containers, and packaging, mechanical components, optical components, and electrical components, and white goods, including household appliances, boilers, and radiators.

In particular, however, the triple-cure mixtures are used as coating materials, preferably surfacers, primers, basecoat materials, topcoat materials or clearcoat materials, preferably as topcoat or clearcoat materials, in particular as clearcoat materials, for producing multicoat color and/or effect, electrically conductive, magnetically shielding or fluorescent paint systems, especially multicoat color and/or effect paint systems. For producing the multicoat paint systems it is possible to employ customary and known wet-on-wet techniques and paint-system constructions.

The resultant clearcoat systems of the invention constitute the outermost coats of the multicoat paint systems, which substantially determine the overall appearance and protect the color and/or effect coats against mechanical and chemical damage and also damage caused by radiation. Consequently, it is in the clearcoat system that deficiencies in hardness, scratch resistance, chemical resistance, weathering stability, etch resistance, wetting, adhesion, condensation resistance, and yellowing stability, and also in the leveling, are manifested in a particularly striking way. The clearcoat systems of the invention, however, exhibit only a low level of yellowing. They are highly scratch resistant, resistant to chemicals, stable to weathering, resistant to etching, firmly adhering, resistant to condensation, hard, and firmly adhering, and show only small losses in gloss after scratching. They have not least a particularly good leveling.

The substrates of the invention coated with coatings of the invention, bonded with adhesive films of the invention, sealed with seals of the invention and/or wrapped or packed with films and/or moldings of the invention therefore have outstanding long-term service properties and a particularly long service life.

### EXAMPLES

### Preparation Example 1

### The Preparation of a Methacrylate Copolymer (A) Containing Carbamate Groups

A reactor equipped with a stirrer, an oil heating system, two dropping funnels, a nitrogen inlet tube, a thermometer, and a reflux condenser was charged with 326.1 parts by weight of methyl carbamate, 489.8 parts by weight of xylene, and 482.6 parts by weight of Cardura® E 10 (glycidyl ester of Versatic® acid from Shell) and this initial charge was heated to 140° C. with stirring. When this temperature had been reached, a monomer mixture of 434.6 parts by weight of hydroxy-methyl methacrylate, 119 parts by weight of styrene, and 163.6 parts by weight of methacrylic acid was metered in to the initial charge at a uniform rate over the course of three hours and an initiator solution of 72 parts by weight of Vazo® 67 (2,2′-azobis[2-methylbutanonitrile] from DuPont), and 181.9 parts by weight of xylene was metered into the initial charge at a uniform rate over the course of three hours. The two feed streams were commenced simultaneously. After the end of the feeds the reaction mixture was cooled to 115° C. over 30 minutes. Thereafter an initiator solution of 12.1 parts by weight of 2,2′-azobis[2-methylbutanonitrile] and 36.9 parts by weight of xylene was metered into the reaction mixture over one hour, after which the reaction mixture was held at 115° C. for one hour more. Following the addition of 2.8 parts by weight of Fascat® 4100 (monobutyltin oxide from Atochem) in 31.3 parts by weight of cyclohexane the reaction mixture was heated to 140° C. with stirring and held at this temperature until the hydroxyl number was 77 mg KOH/g solids. The reaction mixture was subsequently cooled to 100° C. and diluted with 25 parts by weight of methyl isobutyl ketone and 125 parts by weight of xylene.

Unreacted methyl carbamate and the cyclohexane were distilled off under reduced pressure at 130° C. until the methyl carbamate content was <2% by weight. After cooling to 80° C., the reaction mixture was diluted with 125 parts by weight of methoxypropanol. The resulting solution of the methacrylate copolymer (A) containing carbamate groups had a solids content of 70% by weight (60 minutes, forced air oven, 130° C.), an acid number of from 1 to 4 mg KOH/g solids, and a color number of from 4 to 5 (Gardner).

### Preparation Example 2

### The Preparation of a Methacrylate Copolymer (B)

A suitable reactor equipped with a stirrer, two dropping funnels for the monomer mixture and the initiator solution, a nitrogen inlet tube, thermometer, heater, and reflux condenser was charged with 650 parts by weight of an aromatic hydrocarbon fraction having a boiling range of from 158 to 172° C. The solvent was heated to 140° C. Thereafter a monomer mixture of 652 parts by weight of ethylhexyl acrylate, 383 parts by weight of 2-hydroxyethyl methacrylate, 143 parts by weight of styrene, 212 parts by weight of 4-hydroxybutyl acrylate, and 21 parts by weight of acrylic acid was metered into the initial charge at a uniform rate over the course of four hours and an initiator solution of 113 parts by weight of the aromatic solvent and 113 parts by weight of tert-butyl perethylhexanoate was metered into the initial charge at a uniform rate over the course of 4.5 hours. The feeds of the monomer mixture and of the initiator solution were commenced simultaneously. After the end of the initiator feed the resultant reaction mixture was heated at 140° C. with stirring for two hours more and then cooled. The resulting solution of the methacrylate copolymer (A) was diluted with a mixture of 1-methoxypropyl 2-acetate, butylglycol acetate, and butyl acetate.

The resulting solution had a solids content of 65% by weight, determined in a forced air oven (one hour/130° C.), an acid number of 15 mg KOH/g solids, an OH number of 175 mg KOH/g solids, and a glass transition temperature of −21° C.

### Preparation Example 3

### The Preparation of a Component (II)

In a suitable stainless steel reactor, 26.5 parts by weight of Desmodur® Z4470 (isophorone diisocyanate from BAYER Aktiengesellschaft) and 61.8 parts by weight of Basonat® HI 190 B/S (hexamethylene diisocyanate-based isocyanurate from BASF Aktiengesellschaft) were weighed out and mixed with 5.85 parts by weight of Solventnaphtha® and 5.85 parts by weight of butyl acetate.

### Example 1

### The Preparation of a Triple-Cure Mixture

The triple-cure mixture was prepared by mixing 100 parts by weight of component (I) and 26 parts by weight of component (II) from preparation example 3, and homogenizing the resultant mixture.

Component (I) was prepared by mixing the following constituents:
19.90 parts by weight of the methacrylate copolymer solution (A),
21.00 parts by weight of the methacrylate copolymer solution (B),
3.8 parts by weight of Resimene® BM-9539 (commercial methyl- and butyl-etherified melamine resin from Monsanto) as amino resin (C),
1.3 parts by weight of Nacure® 5528 (commercial catalyst, amine-blocked sulfonic acid derivative from King),
0.3 part by weight of Byk® 358 (solvent naphtha-containing additive, 30 percent strength solution of a commercial wetting agent from Byk Chemie),
1.15 parts by weight of Tinuvin® 400 (triazine-containing light stabilizer from Ciba Specialty Chemicals),
1.00 parts by weight of Tinuvin® 292 (HALS light stabilizer from Ciba Specialty Chemicals),
20.05 parts by weight of butyl acetate,
30 parts by weight of Sartomer® 399 (dipentaerythritol pentaacrylate),
1.00 parts by weight of Irgacure® 184 (commercial photoinitiator), and
0.50 part by weight of Lucirin® TPO (commercial photoinitiator, trimethylbenzoyldiphenylphosphine oxide from BASF Aktiengesellschaft)
   and homogenizing the resulting mixture using a dissolver.

The triple-cure mixture had an advantageously long processing time or pot life and was easy to apply.

### Example 2

### The Production of a Multicoat Color Paint System

The triple-cure mixture from example 1 was used as a clearcoat material to produce a multicoat color paint system.

To produce the multicoat paint system, steel test panels which had been coated with an electrocoat in a dry film thickness of from 18 to 22 μm were coated with a water-based surfacer. The resultant water-based surfacer film was baked at 160° C. for 20 minutes so as to give a surfacer coating with a dry film thickness of from 35 to 40 μm. The surfacer coating was subsequently coated with a black aqueous basecoat material from BASF Coatings AG such that curing thereof gave a basecoat having a dry film thickness of from 12 to 15 μm. The resulting aqueous basecoat films were flashed off at 80° C. for 10 minutes. The aqueous basecoat films were coated with the clearcoat material so that, after curing, the resulting clearcoat had a dry film thickness of 40±10 μm. The aqueous basecoat films and the clearcoat films were first cured thermally at room temperature for 5 minutes and then at 80° C. for 10 minutes and were subsequently cured by irradiation with UV from a distance of 20 cm in an IST UV belt unit at 3.3 m/s, with an output of 1 500-1 600 mJ/cm², and, finally, were cured thermally at 140° C. for 20 minutes.

To test the leveling, the clearcoat material was applied electrostatically to the test panels vertically and horizontally. This was done using an eco-bell with direct charging. The leveling was assessed visually as being particularly good.

To determine the scratch resistance and the gloss, the coated test panels were tested by means of the Sand test to DIN 67530 after one day of aging. The initial gloss was 88.8, the residual gloss after the end of the test 76.8. The difference in gloss was therefore 12.0, indicating the very high scratch resistance of the coating.

The wetting and adhesion of the clearcoat material were tested by means of the cross-cut test to DIN ISO 2409:1994-10. The treated test panels gave cross-cut indices of GT 0 or GT 1, underscoring the very good wetting and intercoat adhesion.

To evaluate the condensation resistance of the clearcoat, the test panels were subjected to a constant condensation climate (CCC) test to DIN 50017 and 53209 after three days of aging. The multicoat paint systems showed no dulling and no swelling. Blister indices of m 2/g 1 were obtained. After 3 hours in the CCC test, the treated test panels still gave cross-cut indices of GT 0 or GT 1.

Additionally, the micropenetration hardnesses were determined using a Fischerscope H100V with an applied force of 25.6 mN. The result was a universal hardness of 182.9 N/mm² with a standard deviation of 3.2 and an average penetration depth of 2.3 μm.

In the gradient oven chemicals test, which is known in the art, the multicoat paint system only showed damage above 75° C., at 43° C., at 60° C., and at 50° C. for 24-hour exposure respectively to tree resin, NaOH, pancreatin, and sulfuric acid.

1. A multicomponent system at least comprising
(I) at least one component comprising
(A) at least one oligomer and/or polymer containing on average at least two allophanate groups, carbamate groups or at least one carbamate group and at least one allophanate group,
(B) at least one oligomer and/or polymer containing on average at least two isocyanate-reactive functional groups,
(C) at least one partly or fully alkylated amino resin, and
(D) at least one compound containing on average at least two groups which can be activated with actinic radiation; and
(II) at least one component comprising
(E) at least one polyisocyanate,
with the proviso that
the equivalents ratio of isocyanate groups in component (II) to isocyanate-reactive functional groups in component (I) is from 0.2:1 to 1:0.2 and
the equivalents ratio of allophanate groups and/or carbamate groups in the oligomer and/or polymer (A) to the N-methylol ether groups or the N-methylol and N-methylol ether groups in the amino resin (C) is from 0.2:1 to 1:0.2.

2. The multicomponent system as claimed in claim 1, wherein the equivalents ratio of
isocyanate groups+N-methylol ether groups or N-methylol and N-methylol ether groups (crosslinking agent groups) to
isocyanate-reactive functional groups+allophanate groups and/or carbamate groups (binder groups)
is from 0.2:1 to 1:0.2.

3. The multicomponent system as claimed in claim 2, wherein the equivalents ratio of crosslinking agent groups to binder groups is from 0.25:1 to 1:0.25.

4. The multicomponent system as claimed in claim 1, wherein the equivalents ratio of isocyanate groups in component (II) to isocyanate-reactive functional groups in component (I) is from 0.3:1 to 1:0.3.

5. The multicomponent system as claimed in claim 1, wherein the equivalents ratio of allophanate groups and/or carbamate groups in the oligomer and/or polymer (A) to the N-methylol ether groups or the N-methylol and N-methylol ether groups in the amino resin (C) is from 0.3:1 to 1:0.3.

6. The multicomponent system as claimed in claim 1, wherein the oligomers and polymers (A) and (B) are selected from the group consisting of random, alternating, and block, linear, branched, and comb polyaddition resins, polycondensation resins, and addition (co)polymers of ethylenically unsaturated monomers.

7. The multicomponent system as claimed in claim 6, wherein the polyaddition resins and polycondensation resins are selected from the group consisting of polyesters, alkyds, polyurethanes, polylactones, polycarbonates, polyethers, epoxy resin-amine adducts, polyureas, polyamides and polyimides and mixtures thereof, and the addition (co)polymers are selected from the group consisting of (meth)acrylate (co)polymers and polyvinyl esters and mixtures thereof.

8. The multicomponent system as claimed in claim 1, wherein the oligomer and/or polymer (A) comprise/comprises a minor amount of isocyanate-reactive functional groups.

9. The multicomponent system as claimed in any of claim 1, wherein the oligomer and/or polymer (B) comprise/comprises a minor amount of allophanate groups and/or carbamate groups.

10. The multicomponent system as claimed in claim 8 or 9, wherein the minor amount of allophanate groups is up to 30 equivalent %, based on the total allophanate groups and/or carbamate groups and isocyanate-reactive functional groups present in each case in the oligomer and/or polymer (A) or in the oligomer and/or polymer (B).

11. The multicomponent system as claimed in claim 1, wherein the isocyanate-reactive functional groups are selected from the group consisting of hydroxyl groups, thiol groups, and primary and secondary amino groups and mixtures thereof.

12. The multicomponent system as claimed in claim 1, wherein the amino resin (C) is alkylated with methyl groups and/or n-butyl groups.

13. The multicomponent system as claimed in claim 1, wherein the groups of the compound (D) which can be activated with actinic radiation contains at least one bond which can be activated with actinic radiation.

14. The multicomponent system as claimed in claim 13, wherein a bond which can be activated with actinic radiation is a carbon-carbon double bond (“double bond”) or carbon-carbon triple bond (“triple bond”).

15. The multicomponent system as claimed in claim 14, wherein the groups which can be activated with actinic radiation are selected from the group consisting of (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups; ethenylarylene ether, dicyclopentadienyl ether, norbornenyl ether, isoprenyl ether, isopropenyl ether, allyl ether, and butenyl ether groups; and ethenylarylene ester, dicyclopentadienyl ester, norbornenyl ester, isoprenyl ester, isopropenyl ester, allyl ester, and butenyl ester groups and mixtures thereof.

16. The multicomponent system as claimed in claim 15, wherein the groups which can be activated with actinic radiation are acrylate groups.

17. The multicomponent system as claimed in claim 1, wherein the polyisocyanate (E) comprises blocked isocyanate groups in minor amounts.

18. The multicomponent system as claimed in claim 1, wherein the polyisocyanate (E) comprises at least one group which can be activated with actinic radiation.

19. The multicomponent system as claimed in claim 1, wherein component (I) contains
from 5 to 30% by weight of (A),
from 5 to 30% by weight of (B),
from 1 to 10% by weight of (C), and
from 20 to 70% by weight of (D),
based in each case on the solids of component (I).

20. The multicomponent system as claimed in claim 1, wherein component (II) contains, based on the solids, from 50 to 100% by weight of polyisocyanate (E).

21. The multicomponent system as claimed in claim 1, wherein component (I) and/or component (II) comprise/comprises at least one additive (F).

22. A mixture comprising a multicomponent system as claimed in claim 1, curable thermally and with actinic radiation.

23. The mixture as claimed in claim 22, wherein the mixture is prepared by mixing at least one component (I) and at least one component (II) with one another and homogenizing the resulting mixture.

24. The mixture as claimed in claim 23, wherein component(s) (I) is (are) mixed with component(s) (II) in a weight ratio of from 20:1 to 2:1.

25. A composition selected from the group consisting of moldings, films, coating materials, adhesives, and sealants comprising a mixture as claimed in claim 22.

26. A composition as claimed in claim 25, wherein the moldings, films, coatings, adhesive films or seals comprise the wrapping, packaging, coating, impregnation, adhesive bonding or sealing of means of transport, including aircraft, boats, rail vehicles, vehicles driven by muscle power and motor vehicles, and parts thereof, the interior and exterior of buildings and parts thereof, furniture, doors, windows, and also, in the context of industrial coating, hollow glassware, coils, containers, and packaging, mechanical components, optical components, and electrical components, and white goods, including household appliances, boilers, and radiators.
